(19) United States
(12) Patent Application Publication
(10) Pub. No.: US 2023/0013062 A1
(43) Pub. Date: Jan. 19, 2023

(54) AUTHENTICATION SYSTEM, AUTHENTICATION METHOD, AND NON-TRANSITORY COMPUTER READABLE STORAGE

(71) Applicant: JAPAN COMPUTER VISION CORP., Tokyo (JP)

(72) Inventors: Lidong MA, Tokyo (JP); Gaku TAKEDA, Tokyo (JP); Chikashi OKAMOTO, Tokyo (JP); Kenichi YOSHIMURA, Tokyo (JP)

(73) Assignee: JAPAN COMPUTER VISION CORP., Tokyo (JP)

(21) Appl. No.: 17/526,328

(22) Filed: Nov. 15, 2021

(30) Foreign Application Priority Data
Jul. 14, 2021 (JP) 2021-116079

(51) Int. Cl. G06K 9/00; G06K 9/62; G06K 9/03; G06F 21/32

(52) U.S. Cl. CPC G06K 9/00288; G06K 9/6215; G06K 9/6217; G06K 9/00926; G06K 9/036; G06F 21/32

(57) ABSTRACT

An authentication system includes first and second authentication devices. The first authentication device judges whether a relationship between a first similarity based on a captured image and a registered image between a subject of authentication that is a person in the captured image and a subject of comparison that is a person in the registered image by the first authentication device. When it is judged that a predetermined condition is satisfied, the first authentication device instructs a second authentication device to perform identification authentication. When an instruction is received from the first authentication device, the second authentication device identifies a relationship between a second similarity that is a similarity calculated based on a captured image and a registered image between the subject of authentication and the subject of comparison by the second authentication device, and performs identification authentication of the subject of authentication according to an identification result.

### CROSS-REFERENCE TO RELATED APPLICATION(S)

The present application claims priority to and incorporates by reference the entire contents of Japanese Patent Application No. 2021-116079 filed in Japan on Jul. 14, 2021.

### BACKGROUND OF THE INVENTION

### 1. Field of the Invention

The present invention relates to an authentication system, an authentication method, and a non-transitory computer readable storage medium.

### 2. Description of the Related Art

Conventionally, systems for managing visitors by face recognition have been proposed. For example, U.S. Pat. No. 6,858,914 discloses a locking system that unlocks an entrance door with a locking device by performing authentication using facial images of a visitor imaged by an imaging device.

However, the above conventional technique does not necessarily appropriately achieve both high accuracy of authentication and efficiency of authentication.

For example, in the above conventional technique, a facial image of a visitor captured by an imaging device arranged at an entrance is transmitted to a face recognition cloud of a face recognition system. Moreover, in the above conventional technique, the face recognition cloud performs authentication of a visitor by comparing the facial image of the visitor captured by the imaging device with information relating to a recorded facial image of the visitor, and by comparing a date and time at which the facial image is captured and a visiting date and time registered in advance, and when the authentication succeeds, the locking device unlocks the entrance.

By the conventional technique as described above, for example, even when there is a possibility that the face recognition cloud has made false authentication, the possibility of false authentication cannot be detected and, furthermore, because authentication processing is always performed in the face recognition cloud, time necessary for authentication further increases.

Therefore, in the above conventional technique, for example, both high accuracy of authentication and efficiency of authentication are not necessarily achieved appropriately.

### SUMMARY OF THE INVENTION

It is an object of the present invention to at least partially solve the problems in the conventional technology.

According to one aspect of an embodiment, an authentication system comprising a first authentication device and a second authentication device that has a different authentication performance from the first authentication device. the first authentication device includes a judging unit that judges whether a relationship between a first similarity and a threshold to be a judgment criterion of identification authentication satisfies a predetermined condition, the first similarity being a similarity calculated based on a captured image and a registered image that is registered in advance between a subject of authentication that is a person in the captured image and a subject of comparison that is a person in the registered image, and being a similarity calculated by the first authentication device. The first authentication device includes an instructing unit that instructs the second authentication device to perform identification authentication of the subject of authentication when the judging unit judges that the relationship satisfies the predetermined condition. The first authentication device includes an informing unit that informs the subject of authentication of information relating to an authentication result. the second authentication device includes an identifying unit that identifies, when an instruction is received from the instructing unit, a relationship between a second similarity and the threshold, the second similarity being a similarity calculated based on the captured image and the registered image between the subject of authentication and the subject of comparison, and being a similarity calculated by the second authentication device. The second authentication device includes an authenticating unit that performs identification authentication of the subject of authentication according to an identification result obtained by the identifying unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining an overview of authentication processing according to an embodiment;

FIG. 2 is a diagram illustrating a configuration example of an imaging device according to the embodiment;

FIG. 3 is a diagram illustrating a configuration example of a server device according to the embodiment;

FIG. 4 is a diagram illustrating an example of registration information database;

FIG. 5 is a flowchart showing a procedure of identification processing to identify a relationship between a first similarity and a threshold;

FIG. 6 is a sequence diagram showing a procedure of authentication processing performed according to the relationship between the similarity and the threshold;

FIG. 7 is a sequence diagram showing a procedure of authentication processing performed according to the relationship between the similarity and the threshold; and

FIG. 8 is a hardware configuration diagram illustrating an example of a computer that implements functions of the imaging device.

### DETAILED DESCRIPTION OF THE PREFERRED EMBODIMENTS

Hereinafter, a form (hereinafter, “embodiment”) to implement an authentication system, an authentication method, and an authentication program according to the present application will be explained in detail with reference to the drawings. The embodiment is not intended to limit the authentication system, the authentication method, and the authentication program according to the present application. Moreover, throughout respective embodiments, like reference symbols are assigned to like parts, and duplicated explanation will be omitted.

### 1. Introduction

In face recognition, identification is authenticated based on whether a similarity of a face pattern to a threshold to be a criterion of authentication is high or low. If the threshold is elevated, while false acceptance of authenticating a subject of authentication as a different person decreases, a problem arises that false rejection of not authenticating a subject of authentication as himself/herself, but recognizing as an unregistered person increases.

To solve such a problem, it is necessary to recognize a relationship between the similarity and the threshold appropriately by calculating the similarity accurately. Thus, a method in which calculation of the similarity is performed not in a terminal device that captures a facial image, but in a server device that has more resource and a higher authentication performance than the terminal device is considered.

However, in the above-mentioned method, a series of processes that a facial image captured by a terminal device is transmitted to a server device, identification authentication is performed by the server device, and an authentication result is returned to the terminal device is necessary, and there is a problem that time until the authentication result is obtained increases.

The present invention has been achieved in view of the above situation, and its object is to provide a technique of achieving both high accuracy of authentication and efficiency of authentication appropriately. For this purpose, in the present invention, the face recognition with respect to a subject of authentication is performed in a terminal device in normal time, and when it is determined that a risk of false authentication is high considering a relationship between a similarity and a threshold, face recognition is again performed in a server device.

### 2. Overview of Authentication Processing

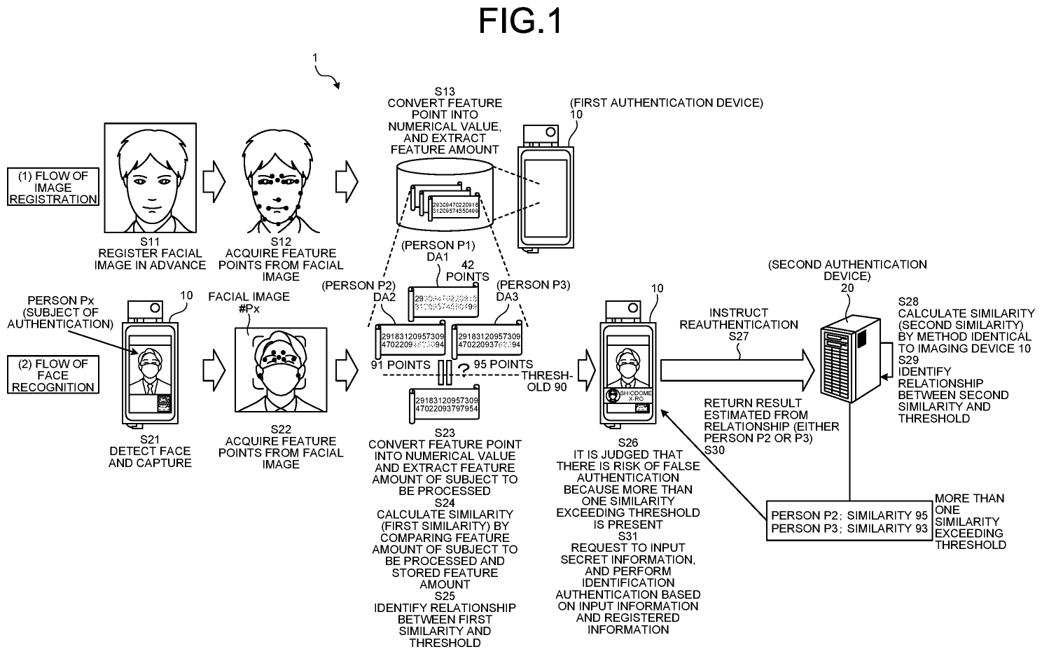

First, an overview of authentication processing according to the embodiment will be explained by using FIG. 1. FIG. 1 is a diagram for explaining the overview of the authentication processing according to the embodiment. The authentication processing illustrated in FIG. 1 is implemented by an authentication system 1.

### 2-1. Authentication System

The authentication system 1 includes an imaging device 10 and a server device 20. The imaging device 10 and the server device 20 are connected through a network N (not illustrated) wiredly or wirelessly in a communication-enabled manner. The authentication system 1 illustrated in FIG. 1 may include the arbitrary number of the imaging devices 10 and the arbitrary number of the server devices 20.

The imaging device 10 is an example of a first authentication device, and performs authentication of identity of a subject of authentication by using an arbitrary face recognition technique. Moreover, the imaging device 10 has an imaging function in addition to an authentication function, and images a facial image by detecting a face of a person. For example, the imaging device 10 authenticates identification of the subject of authentication based on a relationship between a calculated similarity and a predetermined threshold to be a judgement criterion of identification authentication.

The imaging device 10 can be implemented by, for example, a smartphone, a tablet terminal, a laptop personal computer (PC), a desktop PC, a mobile phone, a personal digital assistant (PDA), and the like.

Furthermore, the imaging device 10 is assumed to be installed at an entrance gate of facilities (for example, a company, a store, or the like) for attendance and leave management of employees.

The server device 20 is an example of a second authentication device, and performs identification authentication of a subject of authentication by using an arbitrary face recognition technique. For example, the server device 20 calculates a similarity between the subject of authentication that is a person in a captured image and a subject of comparison that is a person in a registered image based on the captured image and the registered image that is registered in advance. The server device 20 then authenticates identification of the subject of authentication based on the relationship between the calculated similarity and the predetermined threshold being a judgement criterion of identification authentication.

Because the server device 20 has more resources and higher specifications than the imaging device 10, the server device 20 can be considered to have high authentication performance. Moreover, the predetermined threshold herein can be adjusted appropriately so as to maintain a balance between false acceptance and false rejection. Therefore, the predetermined threshold is not necessary to always be a constant value. On the other hand, the threshold may be a common value between the imaging device 10 and the server device 20.

Furthermore, as described above, the imaging device 10 can be regarded as a so-called edge computer that performs edge processing at a position close to the subject of authentication, while the server device 20 can be regarded as a cloud computer. Moreover, although not illustrated in FIG. 1, the authentication system 1 according to the embodiment may further include a terminal device T that is an information processing terminal (for example, smartphone or the like) used by a user (subject of authentication). 2-2. Specific Example of Authentication Processing

Subsequently, a specific example of the authentication processing (face recognition) performed in the authentication system 1 will be explained. In the authentication processing according to the embodiment, a user to be a subject of authentication is request to register a facial image in advance. In the following, a flow of image registration and a flow of face recognition will be separated and independently explained. Although it will be explained with the similarity represented by a numeric value from “1” to “100”, and a unit as “point” in the following embodiment, it is not necessarily limited to this example. For example, the similarity may be represented by a numeric value from “0” to “1”, and the unit may be “mark”. Furthermore, the similarity may be represented without any unit.

### Flow of Image Registration

For example, an arbitrary user Ux can register a facial image of himself/herself in the imaging device 10 by using the terminal device T (step S11). The facial image used for registration may be one captured by the terminal device T, or one captured by another method.

When the imaging device 10 accepts registration of a facial image, the imaging device 10 acquires a feature point indicating a facial pattern of the user Ux from the registered facial image (registered image) (step S12). Moreover, the imaging device 10 converts the feature point into numeric values, and thereby extracts a feature amount corresponding to the feature point (step S13). The extracted feature amount is stored in a database (registration information database 121) included in the imaging device 10. Furthermore, the extracted feature amount may be stored in a database (registration database 221) included in the server device 20 also. According to such a database, a sequence of numbers representing a feature amount of a face of a relevant user is managed per user.

As for the extraction of a feature amount at steps S12 to S13, when it is performed in the server device 20, the extracted feature amount may be registered in the database (registration information database 221) included in the server device 20. In such a case, the imaging device 10 may acquire the feature amount from the registration information database 221 without performing processing at steps S12 to S13, and may store the acquired feature amount in the registration information database 121 in the imaging device 10 itself. As described, extraction of a feature amount may be performed by either the imaging device 10 or the server device 20, but an algorithm used for extraction of a feature amount is preferable to be common between the two.

### Flow of Face Recognition

The imaging device 10 performs authentication of identification for a user, the face of which is detected as a subject of authentication out of users that have registered a facial image, in a state in which a facial image is registered as described at steps S11 to S13.

According to the example in FIG. 1, having detected a face of a person Px, the person Px is recognized as a subject of authentication, and a facial image #Px is captured (step S21).

Next, the imaging device 10 acquires a feature point indicating a facial pattern of the subject of authentication from the facial image #Px (step S22).

Moreover, the imaging device 10 converts the acquired feature point into a numeric value, and thereby extracts a feature amount corresponding to the feature point (step S23). The imaging device 10 compares the feature amount to be processed, which is the extracted feature amount, and a stored feature amount that has been stored in a database, to calculate a similarity (step S24). Specifically, the imaging device 10 calculates a similarity indicating how similar the faces are between the subject of authentication, which is the person Px in the facial image *Px, and a subject of comparison that is a person in each registered image by comparing the feature amount of the subject to be processed and the stored feature amount. The similarity thus calculated in the imaging device 10 is denoted as “first similarity”.

FIG. 1 illustrates an example in which the first similarity of “42 points” is calculated by comparing the feature amount of the subject to be processed that is extracted from the facial image #Px and a stored feature amount DA1 that is extracted from a facial image registered by the person P1. Moreover, FIG. 1 illustrates an example in which the first similarity of “91 points” is calculated by comparing the feature amount of the subject to be processed that is extracted from the facial image #Px and a store feature amount DA2 that is extracted from a facial image registered by a person P2. Moreover, FIG. 1 illustrates an example in which the first similarity of “95 points” is calculated by comparing the feature amount of the subject to be processed that is extracted from the facial image #Px and a stored feature amount DA3 that is extracted from a facial image registered by a person P3.

Next, the imaging device 10 identifies a relationship between the first similarity and a threshold to be a judgement criterion of identification authentication (step S25). In the example in FIG. 1, the imaging device identifies a relationship between the first similarity and a threshold “90”. Specifically, the imaging device 10 identifies the relationship between the first similarity and the threshold “90” based on comparison between each of the first similarities “42 points”, “91 points”, and “95 points” and the threshold “90”.

As an example, the imaging device 10 can identify various kinds of relationships, such as a difference from a threshold for a case of exceeding a threshold in which a first similarity, a value of which is largest among first similarities exceeds the threshold, a difference from a threshold in a case of not exceeding a threshold in which a first similarity, a value of which is largest among first similarities does not exceed the threshold, and a case in which more than one first similarity exceeds a threshold among first similarities.

In the example in FIG. 1, more than one similarity that exceeds the threshold “90” is present. Specifically, the first similarity “91” corresponding to the person P2, and the first similarity “95” corresponding to the person P3 exceed the threshold “90”.

Generally, a similarity exceeding such a high value as the threshold “90” is calculated only between a captured image corresponding to a registered image registered by a subject of authentication in advance and a captured image corresponding to the subject of authentication, and a similarity far lower than the threshold “90” is calculated between other registered images and the captured image. This is ascribable to a low possibility of encountering a person that has a resembling face. Even in such an instance, in the example in FIG. 1, more than one similarity exceeding the high threshold “90” is calculated. In this case, it is conjectured that there is an error in the similarity calculated by the imaging device 10. If processing is proceeded with a wrong similarity, a risk of authenticating the person Px as another person, or of authenticating the person Px as an unregistered person increases.

Therefore, in the example in FIG. 1, the imaging device 10 judges that there is a risk of false authentication based on the relationship (more than one similarity exceeding the threshold is present) identified at step S25 (step S26). Moreover, having judged that there is a risk of a false authentication, the imaging device 10 instructs the server device 20 such that identification authentication is performed also in the server device 20 (that is, reauthentication is performed by the server device 20) (step S27).

When receiving an authentication instruction from the imaging device 10, the server device 20 calculates the similarity by a method same as the imaging device 10 (step S28). Specifically, the server device 20 calculates the similarity by the method similar to that at steps S22 to S24. More specifically, the server device 20 compares a feature amount of a subject to be processed and a stored feature amount, and thereby calculates a similarity indicating how similar faces of the subject of authentication that is the person Px in the facial image #Px and a subject of comparison that is a person in each registered image are. The similarity thus calculated by the server device 20 is denoted as “second similarity”.

Next, the server device 20 identifies a relationship between the second similarity and a threshold to be the judgment criterion of identification authentication (step S29). In the example in FIG. 1, the server device 20 identifies a relationship between the second similarity and the threshold “90”.

In FIG. 1, an example in which the second similarity “95 points” is calculated by comparing a feature amount of the subject to be processed extracted from the facial image #Px and the stored feature amount DA2 that that has been extracted from a facial image registered by the person P2 is illustrated. Moreover, in FIG. 1, an example in which the second similarity “93 points” is calculated by comparing a feature amount of the subject to be processed extracted from the facial image #Px and the stored feature amount DA3 that has been extracted from a facial image registered by the person P3 is illustrated. Therefore, in the example in FIG. 1, the server device 20 identifies that more than one similarity that exceeds the threshold as the relationship between the second similarity and the threshold “90”, similarly to the imaging device 10.

Furthermore, in the example, the server device 20 returns a result (for example, the person P2 or the person P3 is the person himself/herself of the subject of authentication) estimated from the relationship (more than one similarity exceeding the threshold is present) identified at step S29 to the imaging device 10 (step S30).

Moreover, the imaging device 10 can recognize that a similar person having a similar face to the person Px, which is the subject of authentication. For example, the imaging device 10 can estimate that the person Px is one of identical twin siblings. That is, according to the example in FIG. 1, the imaging device 10 estimates that the person P2 and the person P3 are twin siblings having similar faces, and either one of them corresponds to the person Px this time.

In the field of face recognition, technique of accurately identifying a subject of authentication out of persons having similar faces (for example, twins) has been a task. Therefore, the imaging device 10 can accept registration of information relating to a similar person, in addition to registration of a facial image, from a user for which presence of another similar person having a similar face has been ascertained. Thus, for example, the imaging device 10 set a twin flag for registered images of respective persons having faces similar to each other. Moreover, in such a state, the imaging device 10 also accepts registration of secret information (for example, a PIN code, or an original body action) that is only known by this person from one of persons having faces similar to each other. Similarly, the imaging device 10 also accepts registration of secret information (for example, a PIN code or an original body action) that is only known by this person from the other person out of persons having similar faces to each other.

In the example in FIG. 1, suppose that a twin flag has been set, and secret information has been registered. In such a situation, having recognized that a similar person having the similar face to the person Px is present, the imaging device 10 requests the subject of authentication to input secret information, and performs identification authentication based on the information (for example, a PIN code or an original body action) input by the subject of authentication and the registered information (step S31). For example, the imaging device 10 performs identification authentication based on with which one out of the registered image of the person P2 and the registered image of the person P3 the secret information input by the subject of authentication is associated. For example, when the secret information associated with the registered image of the person P2 and the secret information input this time coincide with each other, the imaging device 10 can authenticate the person Px, which is the subject of authentication, as the person P2.

Furthermore, although it is not illustrated in FIG. 1, the imaging device 10 informs the person Px of the authentication result (for example, person Px=person P2) acquired at step S31.

As explained so far in FIG. 1, the authentication system 1 according to the embodiment includes the imaging device 10 (first authentication device) and the server device 20 (second authentication device).

The imaging device 10 calculates a similarity (first similarity) between the person Px (subject of authentication) in a captured image and the persons P1, P2, and P3 (subject of comparison) in registered images based on the captured image #Px and the registered images that have been registered in advance, and thereby judges whether a relationship between the calculated similarity and a threshold satisfies a predetermined condition (condition for risk judgement). When determining that the relationship between the first similarity and the threshold satisfies the predetermined condition, the imaging device 10 instructs the server device 20 to perform identification authentication of the subject of authentication.

Having received the authentication instruction from the imaging device 10, the server device 20 calculates a similarity (second similarity) between the person Px (subject of authentication) in the captured image and the persons P1, P2, and P3 (subject of comparison) in the registered images based on the captured image #Px and the registered images, and thereby identifies a relationship between the calculated similarity and a threshold. The server device 20 performs identification authentication of the subject of authentication according to the identification result.

The imaging device 10 relies on the authentication result by the server device 20, and informs the subject of authentication of it as a right authentication result. However, when it is possible to estimate that a person having a similar face to a subject of imaging is present as a result of a relationship identified by the server device 20, the imaging device 10 requests the subject of imaging to input secret information, and when a registered image that is associated with the input secret information is present, and judges that the person in this registered image is the subject of authentication.

According to the authentication system 1 described above, face recognition with respect to a subject of authentication is performed by the imaging device 10 in normal time, and only when it is judged that there is a high risk of false authentication, face recognition is performed again by the server device 20. Therefore, high accuracy of face recognition and efficiency of face recognition are both achieved appropriately.

### 3. Configuration of Devices

Subsequently, the respective devices included in the authentication system 1 will be explained. Specifically, each of the imaging device 10 and the server device 20 included in the authentication system 1 will be explained.

### 3-1. Configuration of Imaging Device

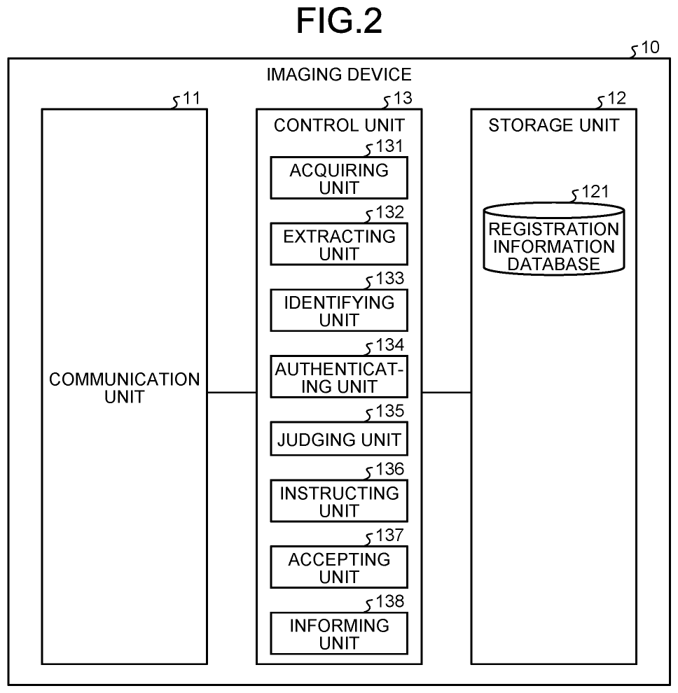

First, the imaging device 10 according to the embodiment will be explained by using FIG. 2. FIG. 2 is a diagram illustrating a configuration example of the imaging device 10 according to the embodiment. As illustrated in FIG. 2, the imaging device 10 includes a communication unit 11, a storage unit 12, and a control unit 13.

### Communication Unit 11

The communication unit 11 is implemented by, for example, a network interface card (NIC) and the like. The communication unit 11 is wiredly or wirelessly connected to a network, and performs transmission and reception of information, for example, with the server device 20 or the terminal device T.

### Storage Unit 12

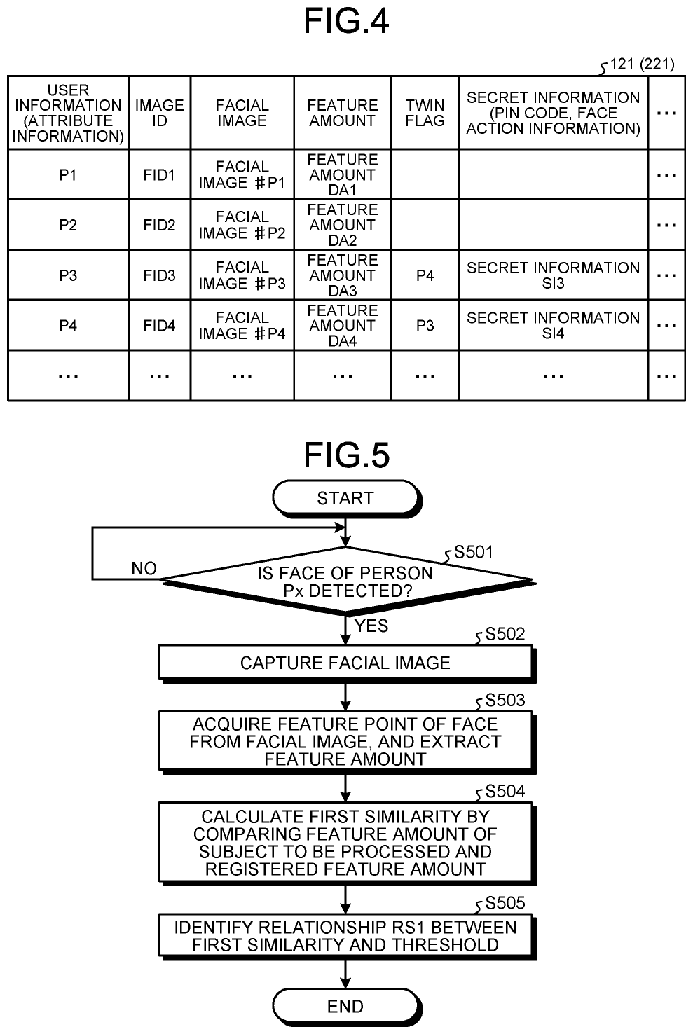

The storage unit 12 is implemented by, for example, a semiconductor memory device, such as a random access memory (RAM) and a flash memory, or a storage device, such as a hard disk and an optical disk. The storage unit 12 includes a registered information database 121. An internal configuration of the registered information database 121 will be explained in FIG. 4.

### Control Unit 13

The control unit 13 is implemented by various kinds of programs (for example, the authentication program according to the embodiment) stored in a storage device in the imaging device 10 being executed by a central processing unit (CPU), a micro processing unit (MPU), or the like, by using the RAM as a work area. Moreover, the control unit 13 is implemented by an integrated circuit, such as an application specific integrated circuit (ASIC) and a field programmable gate array (FPGA).

As illustrated in FIG. 2, the control unit 13 includes an acquiring unit 131, an extracting unit 132, an identifying unit 133, an authenticating unit 134, a judging unit 135, an instructing unit 136, an accepting unit 137, and an informing unit 138, and implements functions of information processing and actions explained in the following. An internal configuration of the control unit 13 is not limited to a configuration illustrated in FIG. 2, but another configuration may be applied as long as it is a configuration to perform information processing described below. Moreover, a connection relationship of the respective processing units included in the control unit 13 is not limited to the connection relationship illustrated in FIG. 2, but another connection relationship may be applied.

### Acquiring Unit 131

The acquiring unit 131 acquires predetermined information that is used for information processing according to the embodiment. For example, the acquiring unit 131 acquires information relating to preregistered information from a user. For example, the acquiring unit 131 acquires a facial image to be registered, and thereby registers the acquired facial image in the registration information database 121.

Moreover, when presence of another similar person having a similar face has been ascertained because the user is one of twins or the like, the acquiring unit 131 may acquire not only the facial image to be registered, but also information relating to the similar person. For example, the acquiring unit 131 acquires information indicating which person and which person have similar faces among persons of facial images to be registered. Furthermore, the acquiring unit 131 (may also be a processing unit other than the acquiring unit 131) can set a twin flag also for registered images of persons having similar faces based on the information relating to the similar person.

Moreover, the acquiring unit 131 may acquire secret information (for example, a PIN code or an original body action) that can be known only by this person, from one of the persons having faces similar to each other. Similarly, the acquiring unit 131 may acquire secret information (for example, a PIN code or an original body action) that can be known only by this person also from the other one of the persons having face similar to each other. The acquired secret information is associated with the registered image in the registration information database 121.

Furthermore, the acquiring unit 131 acquires, when a facial image is captured by an imaging means (not illustrated) included in the imaging device 10, the captured facial image. The acquiring unit 131 recognizes the person of the acquired facial image as the subject of authentication.

### Extracting Unit 132

The extracting unit 132 extracts a feature amount from a facial image. For example, the extracting unit 132 extracts a feature amount from a registered image that is a registered facial image. Moreover, the extracting unit 132 extracts a feature amount from a captured image (for example, a captured image captured this time by the imaging means of the imaging device 10). For example, the extracting unit 132 acquires a feature point indicating a facial pattern from the facial image, converts the acquired feature point into a numerical value, and extracts a feature amount corresponding to the feature point. Moreover, the extracting unit 132 can store the feature amount extracted from the registered image in the registration information database 121.

Information stored in the registration information database 121 may be, for example, copied and stored in the registration information database 221 in the server device 20. Therefore, the internal configuration of the registration information database 121 and an internal configuration of the registration information database 221 may be identical to each other.

### Identifying Unit 133

The identifying unit 133 calculates the first similarity by comparing a feature amount extracted from a captured image (for example a captured image captured this time by the imaging means of the imaging device 10) and a stored feature amount that is stored in the registration information database 121. The identifying unit 133 identifies a relationship between the first similarity and a threshold to be a judgement criterion of identification authentication.

### Authenticating Unit 134

The authenticating unit 134 performs identification authentication of a subject of authentication based on an identification result acquired by the identifying unit 133. For example, the authenticating unit 134 performs the identification authentication of the subject of authentication based on the identification result by the identifying unit 133 when it is judged that a risk of false authentication is low as a result of judgment by the judging unit 135. For example, when more than one similarity exceeding the threshold is present among the first similarities, the authenticating unit 134 can authenticate the subject of authentication as the person in the registered image for which the similarity is calculated. More specifically, the authenticating unit 134 authenticates the subject of authentication as the person in the registered image for which the similarity is calculated when the number of the similarity exceeding the threshold is one among the first similarities, and besides, the similarity exceeds the threshold sufficiently. As a specific example of this point, for example, when the number of similarity exceeding the threshold is one among the first similarities, besides, the similarity exceeds the threshold sufficiently, the authenticating unit 134 may authenticate as the person in the registered image for which this similarity exceeding the threshold is calculated. Moreover, as another example, when the number of similarity exceeding the threshold is one among the first similarities, and besides, the second high similarity is sufficiently lower than the threshold, the authenticating unit 134 may authenticate as the person in the registered image for which the similarity exceeding the threshold is calculated.

### Judging Unit 135

The judging unit 135 judges whether a relationship between the first similarity calculated for a subject of authentication, which is a person in a captured image, and a subject of comparison, which is a person in a registered image, and a threshold to be a judgement criterion of identification authentication satisfies a predetermined condition based on the captured image and the registered image. The predetermined condition herein is a condition to judge a risk of false authentication.

For example, the judging unit 135 judges whether a relationship between a first maximum similarity, a numerical value of which is largest among the first similarities and a threshold satisfies a predetermined relationship. As an example, the judging unit 135 judges whether a difference between the first maximum similarity and the threshold is smaller than a predetermined value. This judgement processing is based on a viewpoint that there is a high possibility that the similarity includes an error (there is a risk of false authentication) if the first maximum similarity takes a value close to the threshold. Note that including an error in a similarity does not mean that the similarity is calculated erroneously (calculation of the similarity itself is correct), but means that the similarities are not correctly reflected between persons shown in the images.

Moreover, as explained above, the threshold may be adjusted to various values according to a situation. Therefore, for example, a predetermined value as a difference may also be varied for a case in which a relatively high value (for example, 90) is set as the threshold and a case in which a relatively low value (for example, 80) is set as the threshold. For example, when the threshold is “90”, the predetermined value as a difference may be “1”, and when the threshold is “80”, the predetermined value as a difference may be “5”.

Furthermore, the judging unit 135 may judge whether more than one similarity exceeding the threshold is present among the first similarities. This judgement processing is based on a point of view that there is a high possibility that a similarity includes an error when more than one similarity exceeding the threshold is present in spite of a tendency that the number of a similarity exceeding the threshold is one.

### Instructing Unit 136

The instructing unit 136 instructs the server device 20 to perform identification authentication of a subject of authentication when the judging unit 135 judges that the relationship between the first similarity and the threshold satisfies the predetermined condition.

For example, the instructing unit 136 instructs the server device 20 to perform identification authentication of a subject of authentication when it is judged that a relationship between the first maximum similarity and the threshold satisfies a predetermined relationship. For example, the instructing unit 136 instructs the server device 20 to perform identification authentication when it is judged that a difference between the first maximum similarity and the threshold is smaller than a predetermined value.

For example, suppose that a condition that the difference between the first maximum similarity and the threshold is smaller than the predetermined value “1” is set in a state in which a relatively high value “90” is set as the threshold. Furthermore, for example, suppose that the first maximum similarity “91” is calculated, the judging unit 135 judges that the condition is satisfied based on a relationship between the first maximum similarity “91” and the threshold “90”. The instructing unit 136 then instructs the server device 20 to perform identification authentication of the subject of authentication. Moreover, for example, suppose that the first maximum similarity “89” is calculated, the judging unit 135 judges that the condition is satisfied based on a relationship between the first maximum similarity “89” and the threshold “90”. The instructing unit 136 then instructs the server device 20 to perform identification authentication of the subject of authentication.

On the other hand, when a relatively low value “80” is set as the threshold, a value “5” of a wider range than the case of the threshold “90” may be set to the predetermined value indicating a difference as the condition. In such a case, suppose that the first maximum similarity “85” is calculated, the judging unit 135 judges that the condition is satisfied based on a relationship between the first maximum similarity “85” and the threshold “80”. Moreover, the instructing unit 136 instructs the server device 20 to perform identification authentication of the subject of authentication. The reason why such processing is performed when the threshold is a relatively low value “80” is because generally when a similarity that is a little over the relatively low threshold “80” is calculated in spite of a tendency that a similarity calculated between a registered image that has been registered in advance by a subject of authentication and a captured image of the subject of authentication exceeds “90”, it can be judged that there is a high possibility of an error in the similarity.

Furthermore, the instructing unit 136 instructs the server device 20 to perform identification authentication of the subject of authentication when it is judged that more than one similarity exceeding the threshold is present among the first similarities. For example, suppose that a condition that more than one first similarity exceeding the threshold is present is set. Moreover, suppose that the first similarity “92” is calculated for the person P2, and the first similarity “93” is calculated for the person P3. In such a case, the judging unit 135 judges that the condition is satisfied based on a relationship between the first similarities “92” and “93” and the threshold “90”. Furthermore, the instructing unit 136 instructs the server device 20 to perform identification authentication of the subject of authentication.

Moreover, suppose that as a result of performing re-authentication performed by the server device 20 in response to the instruction from the instructing unit 136, the second similarity “95” is calculated for the person P2, and the second similarity “85” is calculated for the person P3. In such an example, because the similarity exceeding the threshold “90” is only the second similarity “95”, the server device 20 authenticates the subject of authentication as the person P2.

On the other hand, suppose that as a result of performing re-authentication performed by the server device 20 in response to the instruction from the instructing unit 136, the second similarity “95” is calculated for the person P2, and the second similarity “94” is calculated for the person P3. In this case, more than one similarity exceeding the threshold “90” is present. Therefore, as explained in FIG. 1, the server device 20 identifies a relationship that more than one similarity exceeding the threshold is present, similarly to the imaging device 10, and returns a result that can be estimated from the identified relationship (for example, either the person P2 or the person P3 is the subject of authentication himself/herself) to the imaging device 10. The imaging device 10 request the subject of authentication to input secret information in accordance with the response from the server device 20, and performs identification authentication based on the input information and the registered information.

### Accepting Unit 137

The accepting unit 137 accepts various kinds of information. For example, the accepting unit 137 accepts information transmitted by the server device 20. Moreover, the accepting unit 137 can accept information input by a user through the terminal device T.

### Communicating Unit

### Informing Unit 138

The informing unit 138 informs a subject of authentication of information relating to an authentication result. For example, when an authentication instruction is sent to the server device 20 by the instructing unit 136, the informing unit 138 relies on an authentication result that is a result of identification authentication performed by the server device 20 in accordance with the authentication instruction, and informs the subject of authentication of this authentication result.

Moreover, when the second maximum similarity having a largest numerical value among the second similarities is higher than the first maximum similarity, and besides, the second maximum similarity and the first maximum similarity the informing unit 138 are apart from each other by a predetermined value (for example, “10”) or more, the informing unit 138 suggests the subject of authentication to perform a predetermined action to reacquire the captured image and the registered image. A specific example will be given for this point.

For example, suppose that a condition that a difference between the first maximum similarity and the threshold is smaller than a predetermined value “5” in a state in which a relatively low value “80” is set as the threshold. In such a case, if the first maximum similarity “85” is calculated, the judging unit 135 judges that the condition is satisfied based on a relationship between the first maximum similarity “85” and the threshold “80”. Moreover, the instructing unit 136 instructs the server device 20 to perform identification authentication of the subject of authentication. Suppose as a result of performing re-authentication in response to the instruction from the instructing unit 136, the second similarity “95” is calculated. In this example, the second maximum similarity and the first maximum similarity are apart by “10”. That is, in this example, it is regarded that a difference between the second maximum similarity and the first maximum similarity is significantly large.

Reasons for such a large difference between the second maximum similarity and the first maximum similarity include a bad orientation of the face of the subject of authentication, a movement that interferes imaging performed by the subject of authentication, and the like. Therefore, the informing unit 138 can provide guidance such as “please look forward standing still in front of the camera to capture an image again”.

Moreover, as a reason for a large difference between the second maximum similarity and the first maximum similarity, a defect in the registered image can be considered. Therefore, the informing unit 138 can provide guidance such as “please register a facial image again”.

### 3-2. Configuration of Server Device

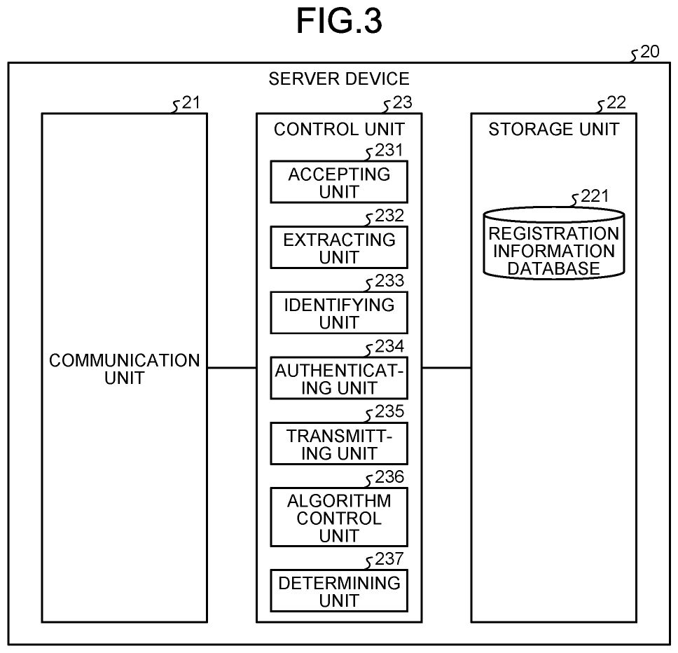

Next, the server device 20 according to the embodiment will be explained by using FIG. 3. FIG. 3 is a diagram illustrating a configuration example of the server device 20 according to the embodiment. As illustrated in FIG. 3, the server device 20 includes a communication unit 21, a storage unit 22, and a control unit 23.

### Communication Unit 21

The communication unit 21 is implemented, for example, by a NIC or the like. The communication unit 21 is wiredly or wirelessly connected to a network, and performs transmission and reception of information with the imaging device 10 or the terminal device T.

### Storage Unit 22

The storage unit 22 is implemented by, for example, a semiconductor memory device, such as a RAM and a flash memory, or a storage device such as a hard disk and an optical disk. The storage unit 22 includes the registration information database 221. An internal configuration of the registration information database 221 will be explained in FIG. 4.

### Control Unit 23

The control unit 23 is implemented by a CPU or an MPU executing various kinds of programs (for example, the authentication program according to the embodiment) stored in the storage unit in the server device 20 by using the RAM as a work area. Moreover, the control unit 23 is implemented, for example, by an integrated circuit, such as an ASIC and an FPGA.

As illustrated in FIG. 3, the control unit 23 includes an accepting unit 231, an extracting unit 232, an identifying unit 233, an authenticating unit 234, a transmitting unit 235, an algorithm control unit 236, and a determining unit 237, and implements or performs functions of information processing and actions explained in the following. An internal configuration of the control unit 23 is not limited to the configuration illustrated in FIG. 3, but another configuration may be applied as long as it is a configuration to perform the information processing described later. Furthermore, a connection relationship of the respective processing units included in the control unit 23 is not limited to the connection relationship illustrated in FIG. 3, but another connection relationship may be applied.

### Accepting Unit 231

The accepting unit 231 accepts various kinds of information. For example, the accepting unit 231 accepts an authentication instruction transmitted by the instructing unit of the imaging device 10. As described above, the authentication instruction is to instruct the server device 20 to perform identification authentication of a subject of authentication when it is judged that a relationship between the first similarity and the threshold satisfies a predetermined condition, and for example, a captured image captured by the imaging device 10 may be included.

### Extracting Unit 232

The extracting unit 232 extracts a feature amount from the captured image (for example, the captured image captured this time by the imaging means of the imaging device 10) in accordance with the authentication instruction. For example, the extracting unit 232 acquires a feature point indicating a facial pattern from the captured image, converts the extracted feature point into a numerical value, and thereby extracts a feature amount corresponding to the feature point.

### Identifying Unit 233

The identifying unit 233 calculates the second similarity by comparing the feature amount extracted by from the captured image and a stored feature amount that is stored in the registration information database 221. The identifying unit 233 identifies a relationship between the second similarity and a threshold to be a judgement criterion of identification authentication.

### Authenticating Unit 234

The authenticating unit 234 performs identification authentication of the subject of authentication based on the identification result obtained by the identifying unit 233. For example, when a similarity exceeding the threshold is just one among the second similarities, the authenticating unit 234 can authenticate the subject of authentication as the person in the registered image for which the similarity is calculated. More specifically, the authenticating unit 234 authenticates the subject of authentication as the person in the registered image for which the similarity is calculated when the number of similarity exceeding the threshold is one among the second similarities, and besides, the similarity exceeds the threshold sufficiently.

### Transmitting Unit 235

The transmitting unit 235 transmits various kinds of information to the imaging device 10. For example, the transmitting unit 235 transmits an estimation result that is estimated from the relationship identified by the identifying unit 233 (for example, either the person P2 or the person P3 is the subject of authentication himself/herself) to the imaging device 10.

### Algorithm Control Unit 236

The algorithm control unit 236 controls such that processing of identifying the relationship between the second similarity and the threshold is performed again, when the relationship that has been identified by the identifying unit 233 satisfies a predetermined condition (condition for risk judgement) (that is, when false authentication is suggested), by using an algorithm that is different from an algorithm used at the time when the relationship is identified by the identifying unit 233. For example, the algorithm control unit 236 controls such that the processing is performed again with an algorithm, a setting value of which is changed, by changing the setting value of the algorithm until a value with which the relationship is estimated not to satisfy the predetermined condition is obtained.

### Determining Unit 237

When the authentication instruction is received from the instructing unit 136, the determining unit 237 determines whether the person in the captured image is the person himself/herself based on the captured image. That is, the determining unit 237 determines whether the captured image is a proper facial image that is acquired by capturing the person himself/herself. For example, the determining unit 237 determines whether the face in the captured image is the face of the person himself/herself by applying an arbitrary image analysis technique to the captured image. For example, the determining unit 237 determines whether the captured image is a proper facial image that is acquired by directly capturing a face of a person, or a fake facial image that is acquired by capturing a face displayed on some kinds of medium (for example, a screen of a smartphone, or the like). Moreover, the identifying unit 233 performs processing of identifying relationship between the second similarity and the threshold when the captured image is determined as a proper facial image by the determining unit 237. A processing unit having similar function as the determining unit 237 may be provided in the imaging device 10. In this case, the imaging device 10 can determine whether a face in a captured image is the face of a person himself/herself by applying an arbitrary image analysis technique to the captured image. Moreover, the imaging device 10 may determine whether the captured image is a proper image that is acquired by capturing a person himself/herself, for example, by biometric authentication (biometrics), not only by an image analysis.

### Registration Information Database 121, 221

The registration information database 121 (221) stores information relating to a facial image accepted from a user as a preregistered information. As described above, the registration information database 121 and the registration information database 221 may have an identical internal configuration. Therefore, the registration information database 121 will be explained as an example. FIG. 4 is a diagram illustrating an example of the registration information database 121.

In the example in FIG. 4, the registration information database 121 includes items of “USER INFORMATION”, “IMAGE IDENTIFIER (ID)”, “FACIAL IMAGE”, “FEATURE AMOUNT”, “TWIN FLAG”, and “SECRET INFORMATION”.

“USER INFORMATION” is various information about a user, and an attribute information, such as address, name, age, and sex of the user. “FACIAL IMAGE” is data of a facial image identified by the “IMAGE ID”. “FEATURE AMOUNT” is information indicating a feature amount extracted from “FACIAL IMAGE”.

“TWIN FLAG” indicates flag information to associate persons having faces similar to each other. For example, “TWIN FLAG” is flag information to associate respective “FACIAL IMAGE” of persons having faces similar to each other. For example, from a user for which presence of another similar person having a face similar thereto because of being twins or the like has been ascertained, information relating to the similar person is accepted. Therefore, “TWIN FLAG” may be added based on information relating to this similar person.

“SECTET INFORMATION” is information that is registered by, for example, a person to which “TWIN FLAG” is set, and may be unique information (for example, information indicating a PIN code or an original body action) that can only be known by this person.

### 4. Processing Procedure

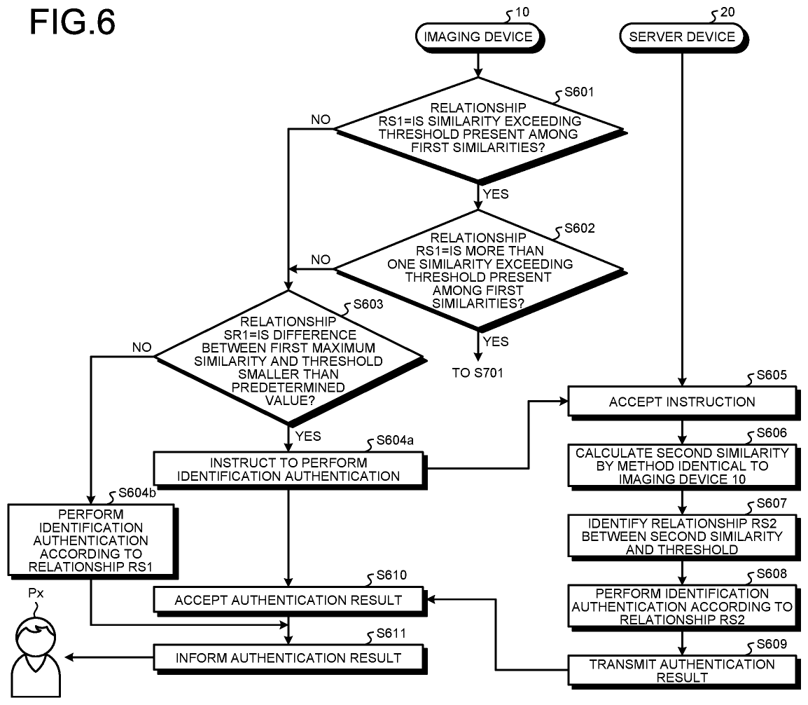

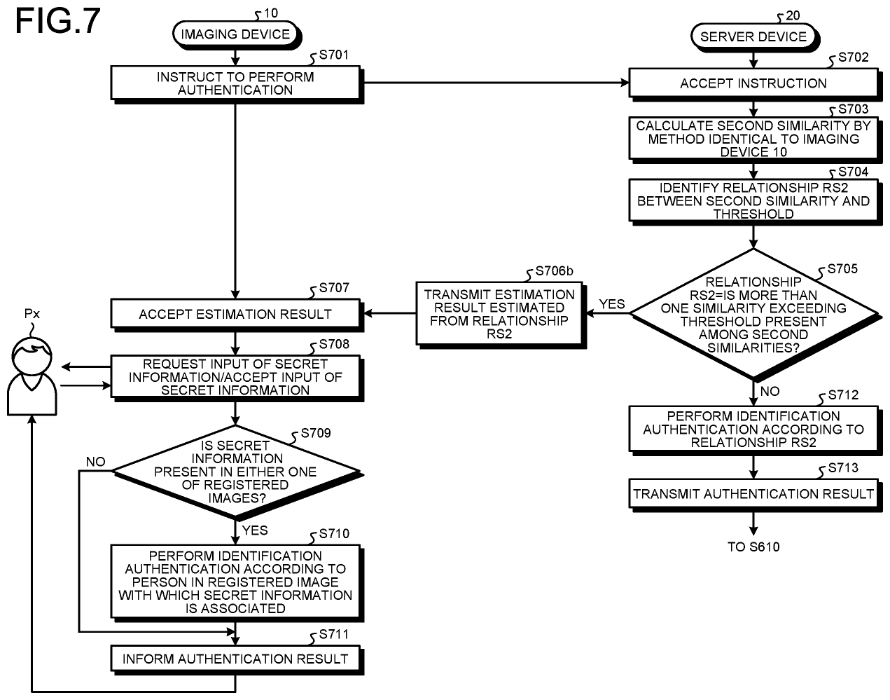

Next, an example of a procedure of the authentication processing according to the embodiment will be explained by using FIG. 5 to FIG. 7. FIG. 5 shows a processing procedure up until a relationship between a similarity and a threshold is identified by the imaging device 10. FIG. 6 and FIG. 7 shows a procedure of authentication processing performed according to whether the relationship identified by the imaging device 10 satisfies a predetermined condition.

### 4-1. Processing Procedure (1)

First, a processing procedure until a relationship between the first similarity and a threshold is identified will be explained by using FIG. 5. FIG. 5 is a flowchart illustrating a procedure of identification processing to identify a relationship between the first similarity and the threshold.

First, the imaging device 10 judges whether a face of the arbitrary person Px is detected (step S501). When a face of the person Px has not been detected (step S501: NO), the imaging device 10 waits until a face of the person Px is detected.

On the other hand, when a face of the person Px is detected (step S501: YES), the imaging device 10 captures a facial image in which the face of the person Px is shown. Moreover, having detected the face of the person Px, the imaging device 10 identifies the person Px as a subject of authentication.

Next, the extracting unit 132 acquires a feature point indicating a facial pattern from the facial image captured at step S502, converts the acquired feature point into a numerical value, and thereby extracts a feature amount corresponding to the feature point (step S503).

Next, the identifying unit 133 calculates the first similarity by comparing the feature amount of the subject of processing extracted at step S503 and a stored feature amount that is stored in the registration information database 121 (step S504). The identifying unit 133 identifies a relationship RS1 between the first similarity and a threshold to be a judgement criterion of identification authentication (step S505).

### 4-2. Processing Procedure (2)

Subsequently, a procedure of authentication processing performed according to whether the relationship RS1 satisfies a predetermined condition (condition for risk judgement) will be explained by using FIG. 6. FIG. 6 is a sequence diagram illustrating a procedure of authentication processing performed according to a relationship between a similarity and a threshold. In FIG. 6, it will be explained, supposing that a relatively high value “90” is set as the threshold to be a judgement criterion of identification authentication.

First, the judging unit 135 of the imaging device 10 judges whether a similarity exceeding the threshold “90” is present among the first similarities based on the relationship RS1 (step S601).

When determining that the similarity exceeding the threshold “90” is present among the first similarities (step S601: YES), the judging unit 135 judges whether more than one the similarity exceeding the threshold “90” is present among the first similarities based on the relationship RS1 (step S602). When it is determined that more than one similarity exceeding the threshold “90” is present among the first similarities (step S602: YES), the processing proceeds to step S701 in FIG. 7. A processing procedure at step S701 and later will be described later.

On the other hand, when judging that a similarity exceeding the threshold “90” is not present among the first similarities (step S601: NO), the judging unit 135 a difference between the first maximum similarity, a numerical value of which is largest among the first similarities and the threshold “90” is smaller than a predetermined value (for example, “1”) based on the relationship RS1 (step S603). Moreover, also when judging that more than one similarity exceeding the threshold “90” is not present among the first similarities (step S602: NO), the judging unit 135 judges whether a difference between the first maximum similarity and the threshold “90” is smaller than a predetermined value (for example, “1”) (step S603).

Next, when it is judged that the difference between the first similarity and the threshold “90” is smaller than the predetermined value (for example “1”) (step S603: YES), the instructing unit 136 instructs the server device 20 to perform identification authentication from a viewpoint that the first maximum similarity is approximate to the threshold “90”, and there is a risk of false authentication (step S604a). As an example of the relationship RS1 when it is judged as “S603: YES”, a situation in which the first similarity exceeding the threshold “90” is only one and is approximate to the threshold “90” is conceivable. As such a first similarity corresponds to the first similarity “91”. Moreover, as another example of the relationship RS1 when it is judged as “S603: YES”, a situation in which a similarity exceeding the threshold “90” is not present among the first similarities and the largest similarity is approximate to the threshold “90” is conceivable. Furthermore, such a first similarity corresponds to the first similarity “89”.

Returning back to explanation of FIG. 6, the accepting unit 231 of the server device 20 accepts an authentication instruction transmitted by the instructing unit 136 (step S605). When the authentication instruction is accepted, the second similarity is calculated by a similar method as the imaging device 10 (step S606). For example, the extracting unit 232 of the server device 20 acquires a feature amount indicating a facial pattern from a facial image of the person Px, converts the acquired feature amount into a numerical value, and thereby extracts a feature amount corresponding to the feature point. The identifying unit 233 of the server device 20 calculates the second similarity by comparing the feature amount of the subject of processing and a stored feature amount that is stored in the registration information database 221.

Moreover, the identifying unit 233 identifies a relationship RS2 between the second similarity and a threshold “90” to be a judgement criterion of identification authentication (step S607). The authenticating unit 234 of the server device 20 performs identification authentication according to the relationship RS2 (step S608). For example, the authenticating unit 234 authenticates the subject of authentication as the person in the registered image for which the similarity is calculated when the similarity exceeding the threshold “90” is one among the second similarities, and besides, the similarity exceeds the threshold “90” sufficiently (for example, when the second maximum similarity=“95”, and the other second similarities are all lower than the threshold “90”).

Next, the transmitting unit 235 of the server device 20 transmits a result of the identification authentication by the authenticating unit 234 to the imaging device 10 (step S609).

The accepting unit 137 of the imaging device 10 accepts the authentication result transmitted by the transmitting unit 235 (step S610). The informing unit 138 of the imaging device 10 informs the person Px, which is the subject of authentication, of the authentication result (step S611). Specifically, the informing unit 138 informs the person Px, which is the subject of authentication, of the authentication result accepted by the accepting unit 137.

Subsequently, when it is judged that the difference between the first threshold and the threshold “90” is larger than a predetermined value (for example, “1”) (step S603: NO), the authenticating unit 134 of the imaging device 10 performs identification authentication according to the relationship RS1 (step S604b).

As an example of the relationship RS1 when it is judged as “S603: NO”, a situation in which the number of similarity exceeding the threshold “90” is one among the first similarities, and besides, this similarity exceeds the threshold “90” sufficiently is conceivable. Moreover, as an example of such a first similarity, the first similarity “93” is conceivable. Therefore, in this example, the authenticating unit 134 authenticates that the person in the registered image for which the first similarity “93” is calculated is the subject of authentication himself/herself.

Furthermore, as an example of the relationship RS1 at the time when it is judged as “S603: NO”, a situation in which a similarity exceeding the threshold “90” is not present among the first similarities, and the largest one is far apart from the threshold “90” is conceivable. Moreover, as an example of such a first similarity, the first similarity “40” is conceivable. Therefore, in this example, the authenticating unit 134 judges the subject of authentication is an unregistered person (stranger), a facial image of which is not registered.

The informing unit 138 informs the person Px, which is the subject of authentication, of the authentication result (step S611). For example, suppose that the person in the registered image for which the first similarity “93” is calculated is the person P2, and the person P2 is authenticated as the subject of authentication himself/herself. In such a case, the informing unit 138 informs the person Px of the authentication result by displaying the authentication result (authentication succeeded) indicating it has authenticated as the person P2 on a screen of the device. On the other hand, when the subject of authentication is judged as an unregistered person for which a facial image is not registered, the informing unit 138 informs the person Px of the authentication result (authentication failed) by displaying error information on a screen of the device.

### 4-3. Processing Procedure (3)

Subsequently, a procedure of authentication processing will be explained by using FIG. 7. FIG. 7 is a sequence diagram showing a procedure of the authentication processing performed according to a relationship between a similarity and a threshold. FIG. 7 shows a procedure of the authentication processing at step S701 shown in FIG. 6 and later.

When it is judged that more than one similarity exceeding the threshold “90” is present among the first similarities (step S602: YES), the instructing unit 136 instructs the server device 20 to perform identification authentication from a viewpoint that there is a risk of false authentication (step S701).

The accepting unit 231 accepts the authentication instruction transmitted by the instructing unit 136 (step S702). When the authentication instruction is accepted, the second similarity is calculated by a method identical to the imaging device 10 (step S703). For example, the extracting unit 232 extracts a feature point indicating a facial pattern from a facial image of the person Px, convers the feature point into a numerical value, and thereby extracts a feature amount corresponding to the feature point. The identifying unit 233 calculates the second similarity by comparing the feature amount of the subject of processing and a stored feature amount that is stored in the registration information database 221.

Moreover, the identifying unit 233 identifies the relationship RS2 between the second similarity and the threshold “90” to be a judgement criterion of the identification authentication (step S704).

The authenticating unit 234 judges whether more than one similarity exceeding the threshold “90” is present among the second similarities based on the relationship RS2 (step S705).

When it is judged that more than one similarity exceeding the threshold “90” is present among the second similarities (step S705: YES), the authenticating unit 234 transmits a estimation estimation result estimated from the relationship RS2 (more than one similarity exceeding the threshold is present) to the imaging device 10 (step S706b).

The accepting unit 137 accepts the estimation result that is estimated from the relationship RS2 (step S707). At this point, the imaging device 10 recognizes that a similar person having a face similar to the person Px, which is the subject of authentication, is present, by considering the estimation result accepted from the server device 20 and the judgement result at step S602.

When presence of a similar person is recognized, the informing unit 138 request the person Px to input unique secret information that can only be known by the person Px, which is the subject of authentication, and accepts secret information input in response to the request (step S708). When information input has not been received even after predetermined time has passed, the informing unit 138 may inform the person Px of the authentication result (authentication failed) by displaying error information on a screen of the device.

When the secret information is accepted, the authenticating unit 134 performs the identification authentication of the subject of authentication based on whether the input secret information is associated with the registered image stored in the registration information database 121. For example, the authenticating unit 134 judges whether a registered image having secret information that matches with the input secret information is present by comparing secret information that has been associated in advance with the registered image to which the twin flag is set and the input secret information (step S709).

When it is judged that a registration image having secret information that matches with the input secret information is present (step S709: YES), the authenticating unit 134 performs the identification authentication according to the person in this registered image (step S710). For example, when the secret information associated with the registered image of the person P2 and the secret information input this time match with each other, the authenticating unit 134 can authenticate the person Px, which is the subject of authentication, as the person P2.

Moreover, the informing unit 138 informs the person Px, which is the subject of authentication, of the authentication result (step S711). For example, when the person P2 is authenticated as the subject of authentication himself/herself, the informing unit 138 informs the person Px of the authentication result by displaying the authentication result (authentication succeeded) indicating that it has authenticated as the person P2 on the screen of the device.

On the other hand, when it is judged that a registered image having secret information that matches with the secret information input this time is not present (step S709: NO), the informing unit 138 informs the person Px of the authentication result (authentication failed) by displaying error information on the screen of the device.

Furthermore, when it is judged that more than one similarity exceeding the threshold “90” is not present among the second similarities (step S705: NO), the authenticating unit 234 performs the identification authentication according to the relationship RS2 (step S712). For example, when a similarity exceeding the threshold “90” is one among the second similarities, and besides, this similarity exceeds the threshold “90” sufficiently (for example, when the second maximum similarity=“95” and the other second similarities are all lower than the threshold “90”), the authenticating unit 234 authenticates the subject of authentication as the person in the registered image for which the similarity is calculated.

Moreover, the transmitting unit 235 transmits a result of the identification authentication by the authenticating unit 234 to the imaging device 10 (step S713). Because processing following this step is identical to the processing from step S610 in FIG. 1, explanation will be omitted.

In FIG. 6, the instructing unit 136 of the imaging device 10 instructs the server device 20 to perform identification authentication when it is judged that more than one similarity exceeding the threshold “90” is present among the first similarities (step S602: YES). However, when it is judged that more than one similarity exceeding the threshold “90” is present among the first similarities, the instructing unit 136 may judge whether the twin flag is set to the respective registered images for which this similarity has been calculated, and when it is judged that the twin flag is set, the instructing unit 136 does not need to instruct the server device 20 to perform authentication. In this case, processing of step S708 and later may be continued to be performed. In this example, because the processing at steps S701 to S707 will be omitted, authentication efficiency can be further improved.

### 5. Modification

The authentication system 1 according to the embodiment described above may be implemented by various different forms other than the embodiment described above. Accordingly, other embodiments of the authentication system 1 will be explained.

### 5-1. Authentication Instruction According to Presence or Absence of Twin Flag

In the embodiment described above, the example in which the instructing unit 136 instructs the server device 20 to perform identification authentication of a subject of authentication when it is judged that a relationship between the first similarity and a threshold to be a judgement criterion of identification authentication satisfies a predetermined condition has been described. However, when it is judged that a similarity exceeding a threshold is one among the first similarities, while a flag (twin flag) indicating that a similar person is present is set to a registered image for which the similarity has been calculated, the instructing unit 136 may send an authentication instruction to the server device 20.

More specifically, the instructing unit 136 may instruct the server device 20 to perform authentication when it is judged that the number of similarity exceeding the threshold “90” is one among the first similarities, and besides, the similarity exceeds the threshold sufficiently, while a flag indicating that a similar person is present is set to the registered image for which the relevant similarity has been calculated.

In the example in FIG. 6, a situation that the first maximum similarity is “93” and the other first similarities are all smaller than the threshold “90” is conceivable as a situation in which the number of similarity exceeding the threshold is one among the first similarities, and the relevant similarity exceeds the threshold sufficiently. Normally, in such a case, the instructing unit 136 does not send an authentication instruction to the server device 20, but authenticates the subject of authentication as the person in the registered image for which the first threshold “93” has been calculated.

However, when the twin flag is set to this registered image for which the first similarity “93” has been calculated, the instructing unit 136 sends an authentication instruction to the server device 20. When the twin flag is set, it means that a similar person having a face similar to the subject of authentication is present, and in such a case, there is a high risk of false authentication. Therefore, the instructing unit 136 sends an authentication instruction to the server device 20 even in a situation in which the number of similarity exceeding the threshold is one among the first similarities, and the relevant similarity exceeds the threshold sufficiently. According to the authentication system 1 as described, the risk of false authentication can be reduced.

### 5-2. Authentication Instruction Using Statistical Threshold

In the embodiment described above, the example in which the instructing unit 136 instructs the server device 20 to perform identification authentication of a subject of authentication when a relationship between the first similarity and a threshold to be a judgment criterion of identification authentication satisfies a predetermined condition has been described. However, not the threshold to be a judgement criterion of identification authentication, but a predetermined threshold based on statistics of the first similarity may be used.

Specifically, the judging unit 135 judges whether a relationship between an average value of the first similarity and a predetermined threshold based on statistics of the first similarity satisfies a predetermined relationship, and when it is judged that the relationship between the average value of the first similarity and the predetermined threshold based on statistics of the first similarity satisfies the predetermined relationship, the instructing unit 136 instructs the server device 20 to perform identification authentication of the subject of authentication.

For example, the predetermined threshold based on statistics of the first similarity includes an upper limit value and a lower limit value, the judging unit 135 judges whether the average value is higher than the threshold, and the instructing unit 136 instructs the server device 20 to perform identification authentication of the subject of authentication when it is judged that the average value is higher than the upper threshold.

Generally, a similarity that exceeds such a high value as the threshold “90” is calculated only between a registered image that is registered in advance by a subject of authentication and a captured image corresponding to the subject of authentication, and a similarity far smaller than the threshold “90” (for example, the similarity of about “20”) is calculated between other registered images and the captured image. However, there is a case in which the first similarities are overall high, and a first average similarity can be around “50” when they are averaged. In such a case, for example, it is estimated that the authentication function of the imaging device 10 is degraded and the first similarities are overall not calculated correctly, or that many of registered images have defects and the first similarities are overall not calculated correctly, or the like.

Therefore, the judging unit 135 judges whether the average value is higher than the upper limit value “40”, and when it is judged that the average value is higher than the upper limit threshold “40”, the instructing unit 136 recognizes that the first similarity is not calculated correctly, and sends an authentication instruction to the server device 20.

Moreover, the judging unit 135 judges whether the average value is lower than the lower threshold, and when it is judged that the average value is lower than the lower limit threshold, the instructing unit 136 may instruct the server device 20 to perform identification authentication of a subject of authentication. Unlike the above example, there is a case in which the first similarities are overall low, and the first average similarity is around “10” when they are averaged. In such a case also, for example, it is estimated that the authentication function of the imaging device 10 is degraded and the first similarities are overall not calculated correctly, or that many of registered images have defects and the first similarities are overall not calculated correctly, or the like.

Therefore, the judging unit 135 judges whether the average value is higher than the lower limit threshold “20”, and when it is judged that the average value is lower than the lower limit threshold “20”, the instructing unit 136 recognizes that the first similarities are not calculated correctly, and sends an authentication instruction to the server device 20.

According to the authentication system 1 as described, a risk of false authentication can be detected from a viewpoint of statistics, and the authentication accuracy can be improved.

### 5-3. Authentication Using Attribute

Moreover, the judging unit 135 may extract a registered image to be used from among registered images based on attribute information indicating an attribute of a subject of authentication, and may judge whether a relationship between the first similarity and the threshold satisfies a predetermined condition.

According to the authentication system 1 as described, for example, when an attribute of a subject of authentication is “thirties, male”, it becomes possible to perform judgement processing, narrowing down the registered facial images to facial images registered by users of the attribute “thirties, male”, and therefore, time necessary for authentication can be reduced.

### 6. Hardware Configuration

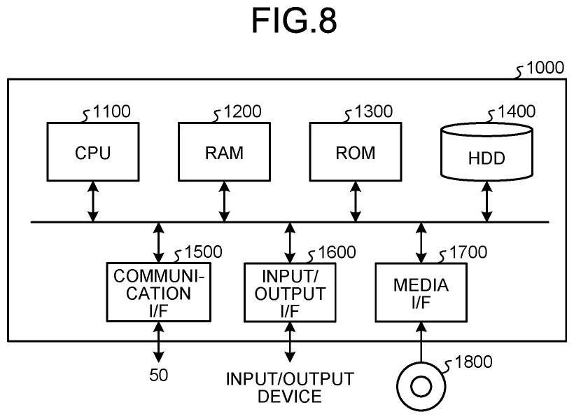

Moreover, the imaging device 10 and the server device 20 described above are implemented by a computer 1000 having a configuration as illustrated in FIG. 8. Hereinafter, the imaging device 10 will be explained as an example. FIG. 8 is a hardware configuration diagram illustrating one example of a computer that implements the functions of the imaging device 10. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates based on a program stored in the ROM 1300 or the HDD 1400, and performs a control of the respective parts. The ROM 1300 stores a boot program that is executed by the CPU 1100 at the time of activation of the computer 1000, a program dependent on hardware of the computer 1000, and the like.

The HDD 1400 stores a program executed by the CPU 1100, and data that is used by the program, and the like. The communication interface 1500 receives data from other devices through a predetermined network, to transmit to the CPU 1100, and transmits data generated by the CPU 1100 to other devices through a predetermined network.

The CPU 1100 controls an output device, such as a display and a printer, through the input/output interface 1600, and controls an input device, such as a keyboard and a mouse. The CPU 1100 acquires data from the input device through the input/output interface 1600. Moreover, the CPU 1100 outputs generated data to the output device through the input/output interface 1600.

The media interface 1700 reads a program or data stored in the storage medium 1800, and provides it to the CPU 1100 through the RAM 1200. The CPU 1100 loads the program from the storage medium 1800 to the RAM 1200 through the media interface 1700, and executes the loaded program. The storage medium 1800 is, for example, an optical recording medium, such as a digital versatile disk (DVD) and a phase change rewritable disk (PD), a magneto-optical recording medium such as a magneto-optical disk (MO), a tape medium, a magnetic recording medium a semiconductor memory, or the like.

For example, the computer 1000 functions as the imaging device 10, the CPU 1100 of the computer 1000 reads and executes these programs from the storage medium 1800, but as another example, these programs can be acquired from other devices through a predetermined communication network.

For example, when the computer 1000 functions as the server device 20, the CPU 1100 of the computer 1000 implements the function of the control unit 23 by executing a program loaded on the RAM 1200.

### 7. Others

Furthermore, out of the processing explained in the respective embodiments described above, all or some of processing explained to be performed automatically can also be performed manually, or all or some o processing explained to be performed manually can also be performed automatically by a publicly-known method. Besides, the procedure of processing, the specific names, and the information including various kinds of data and parameters described in the above document or in the drawings can be arbitrarily changed, unless otherwise specified. For example, the respective information illustrated in the respective drawings is not limited to the information illustrated.

Moreover, the respective components of the respective devices illustrated are of functional concept, and it is not necessarily required to be configured physically as illustrated. That is, specific forms of distribution and integration of the respective devices are not limited to the ones illustrated, and all or some thereof can be configured to be distributed or integrated functionally or physically in arbitrary units according to various kinds of loads, use conditions, and the like.

Furthermore, the respective embodiments described above can be arbitrarily combined within a range not causing a contradiction in the processing.

Some of embodiments of the present application have so far been explained in detail with reference to the drawings, but these are examples and the present invention can be implemented by other forms in which various modifications and improvements are made therein including modes described in a field of disclosure of the invention based on knowledge of those skilled in the art.

Moreover, the term “section, module, unit” described above can be replaced with “means”, “circuit”, or the like. For example, the judging unit can be read as judging means or judging circuit.

According to one aspect of the embodiment, high accuracy of authentication and efficiency of authentication can be both achieved appropriately.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An authentication system comprising:
a first authentication device; and
a second authentication device that has a different authentication performance from the first authentication device, wherein
the first authentication device includes
a judging unit that judges whether a relationship between a first similarity and a threshold to be a judgment criterion of identification authentication satisfies a predetermined condition, the first similarity being a similarity calculated based on a captured image and a registered image that is registered in advance between a subject of authentication that is a person in the captured image and a subject of comparison that is a person in the registered image, and being a similarity calculated by the first authentication device;
an instructing unit that instructs the second authentication device to perform identification authentication of the subject of authentication when the judging unit judges that the relationship satisfies the predetermined condition; and
an informing unit that informs the subject of authentication of information relating to an authentication result, and
the second authentication device includes
an identifying unit that identifies, when an instruction is received from the instructing unit, a relationship between a second similarity and the threshold, the second similarity being a similarity calculated based on the captured image and the registered image between the subject of authentication and the subject of comparison, and being a similarity calculated by the second authentication device; and
an authenticating unit that performs identification authentication of the subject of authentication according to an identification result obtained by the identifying unit.

2. The authentication system according to claim 1, wherein
the first authentication device is a terminal device having an imaging function, and
the second authentication device is a server device that has a higher authentication performance than the first authentication device.

3. The authentication system according to claim 1, wherein
the judging unit judges whether a relationship between a first maximum similarity, a value of which is largest among the first similarities and the threshold satisfies a predetermined relationship, and
the instructing unit instructs the second authentication device to perform identification authentication of the subject of authentication when it is judged that the relationship between the first maximum similarity and the threshold satisfies the predetermined relationship.

4. The authentication system according to claim 3, wherein
the judging unit judges whether a difference between the first maximum similarity and the threshold is smaller than a predetermined value, and
the instructing unit instructs the second authentication device to perform identification authentication when it is judged that the difference between the first maximum similarity and the threshold is smaller than the predetermined value.

5. The authentication system according to claim 3, wherein
the informing unit suggests, when a second maximum similarity, a value of which is largest among the second similarities is larger than the first maximum similarity, and besides, the second maximum similarity and the first maximum similarity are apart by a predetermined value or more, the subject of authentication to perform a predetermined action to reacquire any one of a captured image and a registered image.

6. The authentication system according to claim 1, wherein
the instructing unit instructs the second authentication device to perform identification authentication of the subject of authentication when it is judged that number of a similarity exceeding the threshold is one among the first similarities, and besides, a flag indicating that a similar person is present is added to the registered image for which the similarity is calculated.

7. The authentication system according to claim 1, wherein
the judging unit judges whether more than one similarity exceeding the threshold is present among the first similarities, and
the instructing unit instructs the second authentication device to perform identification authentication of the subject of authentication when it is judged that more than one similarity exceeding the threshold is present among the first similarities.

8. The authentication system according to claim 7, wherein
the informing unit informs the subject of authentication to input predetermined information that is registered in advance by the subject of authentication when the judging unit judges that more than one similarity exceeding the threshold is present among the first similarities, and the relationship identified by the identifying unit indicates that more than one similarity exceeding the threshold is present among the second similarities.

9. The authentication system according to claim 8, wherein
the informing unit controls such that identification authentication of the subject of authentication is performed based on whether the predetermined information input by the subject of authentication is associated with either one of the registered images for which the similarity exceeding the threshold is calculated among the first similarities.

10. The authentication system according to claim 8, wherein
the informing unit requests the subject of authentication to input a password registered in advance by the subject of authentication to the first authentication device, or requests the subject of authentication to show an action that is registered in advance by the subject of authentication to the first authentication device.

11. The authentication system according to claim 1, wherein
the judging unit judges whether a relationship between an average value of the first similarities and a predetermined threshold based on statistics of the first similarity satisfies a predetermined relationship, and
the instructing unit instructs the second authentication device to perform identification authentication of the subject of authentication when it is judged that the relationship between the average value and the predetermined threshold satisfies the predetermined relationship.

12. The authentication system according to claim 1, wherein
the authenticating unit authenticates, when it is judged that number of similarity exceeding the threshold to be a judgement criterion of identification authentication is one, the subject of authentication as the person in the registered image for which the similarity is calculated.

13. The authentication system according to claim 1, wherein
the second authentication device further includes a control unit that controls, when the relationship identified by the identifying unit satisfies the predetermined condition, such that processing of identifying a relationship between the second similarity and the threshold is performed again with an algorithm different from an algorithm that has been used when the identifying unit identifies the relationship.

14. The authentication system according to claim 13, wherein
the control unit controls such that the processing is performed again with an algorithm, a setting value of which is changed, by changing a setting value of the algorithm until a value with which the relationship identified by the identifying unit is estimated not to satisfy the predetermined condition is obtained.

15. The authentication system according to claim 1, wherein
any one of the first authentication device and the second authentication device further includes a determining unit that determines, when an instruction is received from the instructing unit, whether the captured image is a proper image that is acquired by capturing a person himself/herself, and
the identifying unit identifies a relationship between the second similarity and the threshold when the determining unit determines that the captured image is a proper image.

16. The authentication system according to claim 1, wherein
the judging unit extracts a registered image to be processed from among the registered images based on attribute information that indicates an attribute of the subject of authentication, and judges whether a relationship between the first similarity and the threshold satisfies the predetermined condition by using the extracted registered image.

17. An authentication method performed by a first authentication device comprising:
judging whether a relationship between a first similarity and a threshold to be a judgment criterion of identification authentication satisfies a predetermined condition, the first similarity being a similarity calculated based on a captured image and a registered image that is registered in advance between a subject of authentication that is a person in the captured image and a subject of comparison that is a person in the registered image, and being a similarity calculated by the first authentication device;
instructing a second authentication device having a different authentication performance from the first authentication device to perform identification authentication of the subject of authentication when it is judged that the relationship satisfies the predetermined condition at the judging; and
informing the subject of authentication of information relating to an authentication result.

18. An authentication method performed by a second authentication device comprising:
identifying a relationship between a second similarity and a threshold to be a judgment criterion of identification authentication when instructed by the first authentication device having a different authentication performance from the second authentication device, the second similarity being a similarity calculated based on a captured image and a registered image that is registered in advance between a subject of authentication that is a person in the captured image and a subject of comparison that is a person in the registered image, and being a similarity calculated by the second authentication device; and
authenticating identification authentication of the subject of authentication according to an identification result at the identifying.

19. A non-transitory computer readable storage medium having stored therein an authentication program that is executed by a first authentication device and that causes the first authentication device to perform steps of:
judging whether a relationship between a first similarity and a threshold to be a judgment criterion of identification authentication satisfies a predetermined condition, the first similarity being a similarity calculated based on a captured image and a registered image that is registered in advance between a subject of authentication that is a person in the captured image and a subject of comparison that is a person in the registered image, and being a similarity calculated by the first authentication device;
instructing a second authentication device having a different authentication performance from the first authentication device to perform identification authentication of the subject of authentication when it is judged that the relationship satisfies the predetermined condition at the judging; and
informing the subject of authentication of information relating to an authentication result.

20. A non-transitory computer-readable storage medium having stored therein an authentication program that is executed by a second authentication device, that causes the second authentication to perform steps of:
identifying a relationship between a second similarity and a threshold to be a judgment criterion of identification authentication when instructed by the first authentication device having a different authentication performance from the second authentication device, the second similarity being a similarity calculated based on a captured image and a registered image that is registered in advance between a subject of authentication that is a person in the captured image and a subject of comparison that is a person in the registered image, and being a similarity calculated by the second authentication device; and
authenticating identification authentication of the subject of authentication according to an identification result at the identifying.
